(19) United States
(12) Patent Application Publication
(10) Pub. No.: US 2009/0209692 A1
(43) Pub. Date: Aug. 20, 2009

(54) DISPERSING AND/ OR GRINDING AID AGENT FOR DISPERSION AND AQUEOUS SUSPENSION OF MINERAL MATERIALS, DISPERSION AND SUSPENSION OBTAINED AND USE THEREOF

(75) Inventors: Jean-Marc Suau, Lucenay (FR); Olivier Guerret, La Tour De Salvagny (FR); Jean-Bernard Egraz, Ecully (FR); Jacques Mongoin, Quincieux (FR); Christian Jacquemet, Lyon (FR)

Correspondence Address: OBLON, SPIVAK, MCCLELLAND MAIER & NEUSTADT, P.C., 1940 DUKE STREET, ALEXANDRIA, VA, 22314, US

(73) Assignee: COATEX S.A.S., Genay (FR)

(21) Appl. No.: 12/373,366

(22) PCT Filed: Jul. 4, 2007
(86) PCT No.: PCT/IB07/01971

§ 371 Date: Feb. 18, 2009

(30) Foreign Application Priority Data
Jul. 12, 2006 (FR) 06 06326

(51) Int. Cl. C08K 3/22; C08L 37/00; C08L 43/02; C08K 3/28; C08K 3/26; C08K 3/34; C08K 3/30; C08K 3/10; D21H 17/37

(52) U.S. Cl. 524/421; 524/549; 524/547; 524/433; 524/436; 524/428; 524/425; 524/424; 524/444; 524/451; 524/430; 524/437; 162/168.1; 524/449

(57) ABSTRACT

The invention relates to the use of at least one polymer containing at least one monomer selected from acrylic acid or methacrylic acid or mixtures thereof and at least one monomer which is the maleic anhydride as a dispersing and/or grinding aid agent in a fabrication process of an aqueous dispersion and/or suspension of mineral materials, wherein the molar ratio r (acrylic acid and/or methacrylic acid:(maleic anhydride) is strictly confined to the range between 2:1 and 0.1:1.

Another object of the invention consists in the aqueous dispersions and suspensions of mineral materials thus produced and the use thereof in the fabrication of plastics, paper and paintworks.

The general technical domain relating to the present invention is that of methods for the dispersion and grinding of mineral materials in an aqueous medium. The present invention relates more specifically to the development of specific dispersing agents, in the very specific method known as “method for grinding at low solids content without dispersing agent, then concentration to high solids content with dispersing agent present”.

The aqueous dispersions and suspensions of mineral materials such as calcium carbonate, calcium sulphate, kaolinite, titanium dioxide or silicas are used in massive quantities in the paper industry, in particular to render paper or cardboard opaque and printable. For obvious economic reasons, it is a major challenge to use, during the coating of the paper, aqueous dispersions or suspensions of these mineral materials in manipulable (in other words for which the rheology allows persons skilled in the art to manipulate them easily, and in particular to pump them easily in order to transfer them from one tank to another), stable (in other words for which the viscosity changes little over time) form and with as high a solids content as possible (with solids content being defined throughout the present Application as the percentage in dry weight of mineral materials in relation to the total weight of the aqueous dispersion or suspension concerned).

The different production methods for these mineral materials involve 3 individual stages:
grinding in an aqueous medium of said mineral materials, in other words a stage for the reduction of the particle size distribution of the mineral material particles present in dispersion or in suspension; this operation may take place in the presence of a “grinding aid agent” which facilitates the mechanical work for grinding said mineral material particles;
dispersion in an aqueous medium of said mineral materials, introduced in the form of a dry powder, an operation which may take place in the presence of a “dispersing agent” which allows the solids content of the dispersion or the suspension concerned to be increased, while retaining an acceptable rheology, in particular in terms of workability;
concentration in an aqueous medium of an aqueous dispersion or suspension of mineral materials, through thermal and/or mechanical means, with this operation involving the elimination of part of the water contained in the medium with a view to increasing the solids content of the dispersion or the suspension concerned; such an operation may take place if necessary in the presence of a dispersing agent and/or a grinding aid agent.

Persons skilled in the art, producing aqueous dispersions and suspensions of mineral materials such as calcium carbonate in particular, have long known about the use of dispersing and/or grinding aid agents based on acrylic homopolymers and/or copolymers, with a view to maintaining said mineral materials in suspension in the water at high concentrations of dry matter, while granting a stable and manipulable aspect to said aqueous dispersions or suspensions of mineral materials.

They therefore know patents FR 2 603 042, EP 0 100 947, EP 0 127 388, EP 0 129 329 and EP 0 542 644 describing the use of such polymers for the aforementioned purposes, fully or partially neutralised by various neutralisation agents, and with a low molecular weight.

In the context of these applications, they also know patents FR 2 488 814, EP 0 100 948 and EP 0 542 643 which teach how to use the fraction of acrylic homopolymers and/or copolymers, the specific viscosity of which is between 0.3 and 0.8, as measured by the common method described in the patents concerned.

Nonetheless, these different solutions have two disadvantages.

The first is the fact that they use excessive quantities of dispersing and/or grinding aid agents. It is well known however that the presence of too large a quantity of dispersant may have a negative effect on the final characteristics of the paper produced from aqueous dispersions and suspensions of mineral materials containing said agents: in fact, persons skilled in the art know that excessively large doses of dispersant and/or grinding aid agent (in particular if ionic) give the paper a certain water absorbency and a highly distinctive ionic nature, limiting the final printing properties of the paper.

The second problem is linked to the fact that the previously mentioned solutions do not allow the following specific method to be used:
a) grinding of mineral materials in an aqueous medium without the use of a dispersing agent and/or a grinding aid agent and at low concentration of dry matter (the solids content, or the dry weight content of mineral material being less than 40% in relation to the total weight of the suspension),
b) then mechanical and/or thermal concentration, with a view to obtaining an aqueous dispersion and/or suspension of mineral materials with a dry matter content greater than or equal to 55% in relation to the total weight of the dispersion and/or the suspension,
   a dispersing agent being introduced between stage a) and stage b), and/or during stage b), and/or during and after stage b).

In the remainder of the present Application, the Applicant shall refer to such a method using the expression “method for grinding at low solids content without dispersing agent, then concentration to high solids content with dispersing agent present”.

With a view to resolving this particular technical problem, persons skilled in the art know document EP 0 027 996, which describes a production method for aqueous suspensions of mineral materials through a grinding stage in a damp medium without dispersing agent, the suspension then being filtered, and the filter cake then obtained is dried or transformed by the addition of a dispersing agent in a low-viscosity suspension; the grinding stage is carried out at a dry matter concentration below 60% in total weight of the suspension, and the final suspension obtained after addition of the dispersing agent has a dry matter content at least greater than 80% of its total weight.

However, if persons skilled in the art do not choose a suitable dispersing agent to implement, they will not obtain sufficiently high final dry matter content while retaining a manipulable nature for the suspension obtained; yet skilled men in the art are not taught anything on the choice of specific dispersing agents in this document EP 0 027 996, nor on the experimental conditions to be implemented to obtain such a high dry matter content and viscosities compatible with the use of such a suspension: such a document does not therefore allow them to carry out the “method for grinding at low solids content without dispersing agent, then concentration to high solids content with dispersing agent present”.

It is for this very reason that 3 other documents, subsequent to the document EP 0 027 996, have dealt with the same technical problem, but approaching it from the point of view of the choice of specific dispersing agents, which are used to effectively carry out the “method for grinding at low solids content without dispersing agent, then concentration to high solids content with dispersing agent present”. We will later see that these documents present disadvantages for persons skilled in the art.

Persons skilled in the art thus know document EP 1 147 061, which describes a method characterised by the production stages for an aqueous suspension diluted with calcium carbonate, the mineral material dry weight content of which does not exceed 40%, then removal of the water to obtain a solids content of between 45% and 65%, then addition of a dispersing agent if required then, obviously for persons skilled in the art, the subsequent removal of water at reduced pressure to increase the solids content by at least 5%, and lastly mechanical processing of the suspension obtained. This method appears complex to implement and therefore expensive, due to the larger number of stages and the need for apparatus allowing work at a reduced pressure.

Persons skilled in the art also know document WO 01/048093, which provides information on the use of homopolymers and copolymers of acrylic acid with different allyl and vinyl water soluble monomers, with a molecular weight corresponding to a viscosity index ranging from 0.08 to 0.80 based on the method described in the patent application concerned.

Lastly, he also knows patent EP 0 850 685 which teaches another solution, involving the use of copolymers known to persons skilled in the art, acrylic:maleic type copolymers, with a molar ratio between these two units in the range between 10:1 and 0.5:1, and an average molecular weight of between 1000 and 100,000 g/mole, use of acrylic:maleic type copolymers which was already known through previous documents.

As a result, the solution proposed in the document EP 1 147 061 appears too complex and troublesome. With regard to the solutions proposed in the documents WO 01/048093 and EP 0 850 685, although they allow the “grinding at low solids content without dispersing agent, then concentration to high solids content with dispersing agent present” method to be carried out, they nonetheless retain the disadvantage of using excessively large quantities of dispersing agents.

Therefore, with a view to producing aqueous dispersions and/or suspensions of mineral materials through the specific method of “grinding at low solids content without dispersing agent, then concentration to high solids content with dispersing agent present”, the Applicant has developed the use, as a dispersing and/or grinding aid agent, of polymers containing at least one monomer chosen from acrylic acid or methacrylic acid or mixtures thereof, and at least one monomer which is maleic anhydride, said polymer being characterised in that the molar ratio r (acrylic and/or methacrylic acid):(maleic anhydride) is strictly between 2:1 and 0.1:1.

This use provides aqueous dispersions and/or suspensions of mineral materials with:
a high solids content, in other words a solids content greater than 60% of the total weight of said dispersion or suspension,
a manipulable nature, in other words a Brookfield™ viscosity of less than 500 mPa·s, measured after production of said dispersion or suspension, at 100 rpm, and at 25° C.,
a stable nature, in other words for which the Brookfield™ viscosity measured at 100 rpm and at 25° C. alters little over time,
   all of this while using a quantity of dispersing and/or grinding aid agent less than or equal to that used in the prior art, in particular in the documents EP 0 850 685 and WO 01/048093. We thus obtain, for the dispersions or suspensions of mineral materials, the same characteristics as those mentioned above, but with a lower dispersant requirement than in the prior art (this may also result in improved characteristics in terms of solids content, stability and viscosity, for a dispersant requirement identical to the one used in the solutions proposed by the prior art).

This solution seems all the more remarkable since, with the document EP 0 850 685 already proposing a solution to the placing in suspension of the calcium carbonate in accordance with the “grinding at low solids content without dispersing agent, then concentration to high solids content with dispersing agent present” method, with acrylic:maleic copolymers with a molar ratio between these two units of between 10:1 and 0.5:1, the authors of this document had not noticed that a specific molar ratio strictly between 2:1 and 0.1:1 would allow the quantity of polymers used in the case of copolymers (acrylic and/or methacrylic acid):(maleic anhydride) to be reduced, thus improving the final printing properties of the paper.

This molar ratio (in (meth)acrylic acid:maleic anhydride) according to the present invention is therefore defined through a much closer interval (2:1 to 0.1:1) than the one revealed in the document EP 0 850 685 (10:1 to 0.5:1).

Furthermore, it is outside the preferable zone stated in the document EP 0 850 685 which is between 9:1 and 3:1, as indicated in claim 9 of this document. It should be noted that this claim 9 connects this preferable domain to the obtaining of improved (lowered) viscosities for the resulting mineral material suspensions, which also forms part of the technical problem resolved by the present Application.

Lastly, the ratio identified in the present Application appears perfectly justified in the sense that it leads to a remarkable technical effect on the aqueous suspensions of mineral materials obtained, namely the reduction in dispersant required, while maintaining the Brookfield viscosity, the solids content and the stability of these suspensions, or improvement of these properties for a dispersant requirement equal to that of the prior art. This result is all the more surprising since the authors of document EP 0 850 685 had identified, for at least one common technical problem (the reduction in viscosity), a very different monomer ratio interval, according to their claim 9.

Furthermore, the Applicant has also observed that this ratio, if it is preferably chosen between 1.9:1 and 1.1:1, very preferably between 1.5:1 and 1.3:1, provided considerably improved properties in terms of solids content, with a low Brookfield™ viscosity stable over time, for the aqueous dispersions and/or suspensions of mineral materials which they can be used to produce: these properties are clearly illustrated in the examples of the present Application.

Thus, a first object of the invention is the use in a production method of aqueous dispersion and/or suspension of mineral materials including:
a) a grinding stage for mineral materials in an aqueous medium without the use of dispersing agent and/or grinding aid agent and with a percentage of mineral materials dry weight lower than 50%, preferably lower than 40%, very preferably lower than 35% of its weight,
b) then a mechanical and/or thermal concentration stage, with a view to obtaining aqueous dispersions and/or suspensions of mineral materials with a percentage of mineral materials dry weight greater than 55%, preferably greater than 60%, very preferably greater than 65% of its weight,
   at least one polymer containing at least one monomer chosen from acrylic acid or methacrylic acid or mixtures thereof and at least one monomer which is maleic anhydride, said polymer being characterised in that the molar ratio r (acrylic and/or methacrylic acid):(maleic anhydride) is strictly between 2:1 and 0.1:1, and in that said polymer is used as a dispersing agent and is introduced between stage a) and stage b), and/or during stage b), and/or during and after stage b).

This use is also characterised in that the molar ratio r (acrylic and/or methacrylic acid):(maleic anhydride) is preferably between 1.9:1 and 1:1, very preferably between 1.5:1 and 1.3:1.

This use is also characterised in that said polymer may contain at least one other monomer, which is a non-acidic water soluble vinyl monomer, chosen preferably from (meth)acrylamides which may be substituted, polyethylene glycol (meth)acrylates, polyalkylene glycol vinyl ethers, sulphonic vinyl, phosphate (meth)acrylates of polyalkylene glycol, vinyl pyrrolidone and mixtures thereof.

This use is also characterised in that said polymer contains from 0 to 50% in moles, in relation to the total number of monomer moles it contains, of a non-acidic water soluble vinyl monomer, chosen preferably from (meth)acrylamides which may be substituted, polyethylene glycol (meth)acrylates, polyalkylene glycol vinyl ethers, sulphonic vinyl, phosphate (meth)acrylates of polyalkylene glycol, vinyl pyrrolidone and mixtures thereof.

This use is also characterised in that said polymer has a molecular weight of between 3000 g/mole and 150,000 g/mole, preferably between 7000 and 30,000 g/mole, very preferably between 10,000 and 20,000 g/mole.

The Applicant indicates that, in the present Application, the molecular weights as measured and claimed are determined by a steric exclusion chromatography (SEC) method, based on the following method.

A test sample of the polymer solution corresponding to 90 mg of dry matter is introduced into a 10 ml flask.

The mobile phase is added, with 0.04% THF, up to a total mass of 10 g.

The composition of this mobile phase is as follows: NaNO₃: 0.2 mole/L, CH₃COOH: 0.5 mole/L, acetonitrile 5% volume.

The SEC chain consists of a Waters™ 510 type isocratic pump, the flow of which is set to 0.8 mL/min, a Waters 717+ autosampler, an oven containing a “Guard Column Ultrahydrogel Waters™” type precolumn, followed by an “Ultrahydrogel Waters™” type set of columns with a 7.8 mm internal diameter and 30 cm in length, for which the nominal porosities are, in order of connection: 2000, 1000, 500 and 250 Å.

Detection is ensured by a Waters™ 410 type differential refractometer.

The temperature of the oven and the detector is set at 35° C.

The chromatogram is acquired and processed using the software PSS WinGPC Scientific v 4.02.

The SEC is calibrated by a series of sodium polyacrylate standards provided by Polymer Standard Service with the references PAA 18 K, PAA 8K, PAA 5K, PAA 4K, PAA 3K.

The calibration curve is linear and takes into account the correction obtained using the flow marker (THF).

This use is also characterised in that said polymer is neutralised, totally or partially, by a neutralisation agent chosen from calcium or magnesium hydroxides and/or oxides, sodium, potassium, lithium hydroxides or ammonia, or mixtures thereof, very preferably from calcium hydroxides and/or oxides, sodium and potassium hydroxides or ammonia, or mixtures thereof.

This use is also characterised in that said polymer is used at 0.1% to 1.5%, preferably 0.3% to 1.0% in dry weight of said polymer in relation to the dry weight of mineral materials.

This use is also characterised in that said polymer is diluted in solution in the water, with this solution containing between 20% and 60%, preferably between 30% and 50% in dry weight of polymer in relation to its total weight.

This use is also characterised in that said mineral materials are chosen from natural or synthetic calcium carbonate, dolomites, kaolinite, talc, gypsum, lime, magnesia, titanium dioxide, satin white, aluminium trioxide or aluminium trihydroxide, silicas, mica and the mixture of these charges, such as mixtures of talc-calcium carbonate, calcium carbonate-kaolinite, or mixtures of calcium carbonate with aluminium trihydroxide or aluminium trioxide, or mixtures with synthetic or natural fibres, or co-structures of minerals such as talc-calcium carbonate or talc-titanium dioxide co-structures, or mixtures thereof, and in that said mineral materials are chosen preferably from natural or synthetic calcium carbonate or talc or mixtures thereof, and in that they are very preferably chosen from natural or synthetic calcium carbonate or mixtures thereof.

A second object of the invention is an aqueous dispersion or suspension of mineral materials, containing at least one polymer containing at least one monomer chosen from acrylic acid or methacrylic acid or mixtures thereof and at least one monomer which is maleic anhydride, characterised in that said polymer has a molar ratio r (acrylic and/or methacrylic acid):(maleic anhydride) strictly between 2:1 and 0.1:1.

This dispersion or suspension is also characterised in that the molar ratio r (acrylic and/or methacrylic acid):(maleic anhydride) is preferably between 1.9:1 and 1:1, very preferably between 1.5:1 and 1.3:1.

This dispersion or suspension is also characterised in that said polymer may contain at least one other monomer, which is a non-acidic water soluble vinyl monomer, chosen preferably from (meth)acrylamides which may be substituted, polyethylene glycol (meth)acrylates, polyalkylene glycol vinyl ethers, sulphonic vinyl, phosphate (meth)acrylates of polyalkylene glycol, vinyl pyrrolidone and mixtures thereof.

This dispersion or suspension is also characterised in that said polymer contains from 0 to 50% in moles, in relation to the total number of monomer moles it contains, of a non-acidic water soluble vinyl monomer, chosen preferably from (meth)acrylamides which may be substituted, polyethylene glycol (meth)acrylates, polyalkylene glycol vinyl ethers, sulphonic vinyl, phosphate (meth)acrylates of polyalkylene glycol, vinyl pyrrolidone and mixtures thereof.

This dispersion or suspension is also characterised in that said polymer has a molecular weight of between 3000 g/mole and 150,000 g/mole, preferably between 7000 and 30,000 g/mole, very preferably between 10,000 and 20,000 g/mole.

This dispersion or suspension is also characterised in that said polymer is neutralised, totally or partially, by a neutralisation agent chosen from calcium or magnesium hydroxides and/or oxides, sodium, potassium, lithium hydroxides or ammonia, or mixtures thereof, very preferably from calcium hydroxides and/or oxides, sodium and potassium hydroxides or ammonia, or mixtures thereof.

This dispersion or suspension is also characterised in that it contains between 0.1% and 1.5%, preferably between 0.3% and 1.0% in dry weight of said polymer in relation to the dry weight of mineral materials.

This dispersion or suspension is also characterised in that said mineral materials are chosen from natural or synthetic calcium carbonate, dolomites, kaolinite, talc, gypsum, lime, magnesia, titanium dioxide, satin white, aluminium trioxide or aluminium trihydroxide, silicas, mica and the mixture of these charges, such as mixtures of talc-calcium carbonate, calcium carbonate-kaolinite, or mixtures of calcium carbonate with aluminium trihydroxide or aluminium trioxide, or mixtures with synthetic or natural fibres, or co-structures of minerals such as talc-calcium carbonate or talc-titanium dioxide co-structures, or mixtures thereof, and in that said mineral materials are chosen preferably from natural or synthetic calcium carbonate or talc or mixtures thereof, and in that they are very preferably chosen from natural or synthetic calcium carbonate or mixtures thereof.

Another object of the invention is the use of these aqueous dispersions or suspensions of mineral materials in the production of plastics and rubbers, or in the production of aqueous formulations containing mineral materials. The Applicant specifies on the subject of plastic materials that these are the aqueous dispersions or suspensions of mineral materials which, once dried, are included in the composition of said plastic formulations.

A last object of the invention is the use of these aqueous dispersions or suspensions of mineral materials in the production of paper, and more specifically in the production of sheets of paper and in the production of coating mixtures intended for the production of a coated sheet of paper, as well as in the production of paintworks.

### EXAMPLES

### Example 1

This example illustrates the use according to the invention of the polymers described in the present Application and of polymers described in the prior art, as dispersing agents used in the method for grinding at low solids content without dispersing agent, then concentration to high solids content with dispersing agent present.

In each of the tests no. 1 to no. 16, a coarse carbonate is placed in suspension in this water and this suspension is stirred to prevent any sedimentation, circulated in a Dyno-Mill™ type grinder with a fixed cylinder and a rotating impeller, the grinding body of which consists of corundum balls with a diameter between 0.6 mm and 1 mm. The total volume occupied by the grinding material is 1.150 litres, with a mass of 2.9 kg. The grinding chamber has a volume of 1.4 litres. The circumferential speed is 10 m/s. The calcium carbonate suspension is recycled in the grinder until the required particle size distribution is obtained at a rate of 18 litres/h.

The particle size distribution of the suspensions is determined using a Sedigraph™ 5100 granulometer by Micromeritics™.

The calcium carbonate is then concentrated by any means known to persons skilled in the art until the concentration required for the application is obtained.

At this stage of the production, the calcium carbonate takes the form of a solid or pasty cake which must be redispersed to make it manipulable, through the use of a polymer according to the invention or according to the prior art.

The calcium carbonate filter cake, consisting of 67.5% in weight of calcium carbonate and for which the particle size distribution is such that 75% in weight of the particles have a diameter of less than 1 micron, is then dispersed using a polymer according to the prior art or according to the invention.

### Test No. 1

This test illustrates the invention and uses 0.5% in dry weight, in relation to the dry weight of calcium carbonate, of a polymer:
consisting of acrylic acid and maleic anhydride in a molar ratio r of 1.36:1;
with a molecular weight of 19,500 g/mole;
totally neutralised by the sodium hydroxide.

### Test No. 2

This test illustrates the invention and uses 0.5% in dry weight, in relation to the dry weight of calcium carbonate, of a polymer:
consisting of acrylic acid and maleic anhydride in a molar ratio r of 1.87:1;
with a molecular weight of 13,325 g/mole;
totally neutralised by the sodium hydroxide.

### Test No. 3

This test illustrates the invention and uses 0.5% in dry weight, in relation to the dry weight of calcium carbonate, of a polymer:
consisting of acrylic acid and maleic anhydride in a molar ratio r of 1.82:1, and also containing acrylamide in a weight ratio (acrylic acid/maleic anhydride/acrylamide) of 43/32/25;
with a molecular weight of 21,020 g/mole;
totally neutralised by the sodium hydroxide.

### Test No. 4

This test illustrates the invention and uses 0.5% in dry weight, in relation to the dry weight of calcium carbonate, of a polymer:
consisting of acrylic acid and maleic anhydride in a molar ratio r of 1.87:1, and also containing acrylamide in a weight ratio (acrylic acid/maleic anhydride/acrylamide) of 55/40/5;
with a molecular weight of 15,860 g/mole;
totally neutralised by the sodium hydroxide.

### Test No. 5

This test illustrates the prior art and uses 0.5% in dry weight, in relation to the dry weight of calcium carbonate, of a polymer:
consisting of acrylic acid and maleic anhydride in a molar ratio r of 3.17:1;
with a molecular weight of 15,700 g/mole;
totally neutralised by the sodium hydroxide.

### Test No. 6

This test illustrates the prior art and uses 0.5% in dry weight, in relation to the dry weight of calcium carbonate, of a polymer:
consisting of acrylic acid and maleic anhydride in a molar ratio r of 5.2:1;
with a molecular weight of 16,700 g/mole;
totally neutralised by the sodium hydroxide.

### Test No. 7

This test illustrates the prior art and uses 0.5% in dry weight, in relation to the dry weight of calcium carbonate, of a homopolymer of the acrylic acid with a molecular weight of 58,000 g/mole.

The Brookfield™ viscosity of the suspension is measured using an RVT type Brookfield™ viscometer at a temperature of 25° C. and at a rotation speed of 100 rpm with the appropriate mobile.

The viscosity reading is taken after one minute of rotation.

The initial viscosity of the suspension is thus obtained, measured at the instant t=0, and noted μₜ₌₀.

After a break of 8 days for said suspension, and after mechanical stirring of said suspension for 5 minutes using a laboratory stirrer, the Brookfield™ viscosity of said suspension is measured again using an RVT type Brookfield™ viscometer at a temperature of 25° C. and at a rotation speed of 100 rpm with the appropriate mobile, and noted μₜ₌₈.

These Brookfield™ viscosity values are given in table 1.

TABLE 1

| | μₜ₌₀ | μₜ₌₈ |
|---|---|---|
| | (mPa · s) | (mPa · s) |
| Test no. | 100 rpm | 100 rpm |
| 1 (invention) | 160 | 350 |
| 2 (invention) | 220 | 400 |
| 3 (invention) | 200 | 380 |
| 4 (invention) | 240 | 460 |
| 5 (prior art) | 300 | 700 |
| 6 (prior art) | 240 | 600 |
| 7 (prior art) | 250 | 610 |

The reading of table 1 shows that the use of dispersants according to the invention, with the same quantity of dispersant as in the prior art, provides suspensions of calcium carbonate with the same solids content (67.5% of their weight), but lower initial Brookfield™ viscosities, providing good stability over time for said suspensions.

The reading of this table thus clearly shows the technical advantage provided by the use of the polymers in the present invention (in particular through the choice of the molar ratio r of acrylic acid and maleic anhydride), for the properties listed above.

### Example 2

This example illustrates the use according to the invention of the polymers described in the present Application and of polymers described in the prior art, as dispersing agents used in the method for grinding at low solids content without dispersing agent, then concentration to high solids content with dispersing agent present.

For each of the tests, the production protocol for the aqueous suspension of calcium carbonate is identical to the one described in example 1, with the exception that the calcium carbonate filter cake consists of 65% weight calcium carbonate and for which the particle size distribution is such that 80% in weight of the particles have a diameter of less than 1 micron.

### Test No. 8

This test illustrates the invention and uses 0.45% in dry weight, in relation to the dry weight of calcium carbonate, of a polymer:
consisting of acrylic acid and maleic anhydride in a molar ratio r of 1.36:1;
with a molecular weight of 19,500 g/mole;
totally neutralised by the sodium hydroxide.

### Test No. 9

This test illustrates the invention and uses 0.45% in dry weight, in relation to the dry weight of calcium carbonate, of a polymer:
consisting of acrylic acid and maleic anhydride in a molar ratio r of 1.55:1;
with a molecular weight of 19,500 g/mole;
totally neutralised by the sodium hydroxide.

### Test No. 10

This test illustrates the invention and uses 0.45% in dry weight, in relation to the dry weight of calcium carbonate, of a polymer:
consisting of acrylic acid and maleic anhydride in a molar ratio r of 1.80:1;
with a molecular weight of 19,500 g/mole;
totally neutralised by the sodium hydroxide.

### Test No. 11

This test illustrates the invention and uses 0.45% in dry weight, in relation to the dry weight of calcium carbonate, of a polymer:
consisting of acrylic acid and maleic anhydride in a molar ratio r of 1.24:1;
with a molecular weight of 19,500 g/mole;
totally neutralised by the sodium hydroxide.

### Test No. 12

This test illustrates the invention and uses 0.45% in dry weight, in relation to the dry weight of calcium carbonate, of a polymer:
consisting of acrylic acid and maleic anhydride in a molar ratio r of 1.20:1;
with a molecular weight of 19,500 g/mole;
totally neutralised by the sodium hydroxide.

### Test No. 13

This test illustrates the invention and uses 0.45% in dry weight, in relation to the dry weight of calcium carbonate, of a polymer:
consisting of acrylic acid and maleic anhydride in a molar ratio r of 1.36:1;
with a molecular weight of 19,500 g/mole;
of which 60% in moles of the acid functions are neutralised by the sodium hydroxide and 40% in moles are neutralised by the lithium hydroxide.

### Test No. 14

This test illustrates the invention and uses 0.45% in dry weight, in relation to the dry weight of calcium carbonate, of a polymer:
consisting of acrylic acid and maleic anhydride in a molar ratio r of 1.36:1;
with a molecular weight of 19,500 g/mole;
of which 60% in moles of the acid functions are neutralised by the sodium hydroxide and 40% in moles are neutralised by the potassium hydroxide.

### Test No. 15

This test illustrates the invention and uses 0.45% in dry weight, in relation to the dry weight of calcium carbonate, of a polymer:
consisting of acrylic acid and maleic anhydride in a molar ratio r of 1.36:1;
with a molecular weight of 19,500 g/mole;
of which 60% in moles of the acid functions are neutralised by the sodium hydroxide and 40% in moles are neutralised by the ammonia.

### Test No. 16

This test illustrates the invention and uses 0.45% in dry weight, in relation to the dry weight of calcium carbonate, of a polymer:
consisting of acrylic acid and maleic anhydride in a molar ratio r of 1.36:1;
with a molecular weight of 19,500 g/mole;
of which 60% in moles of the acid functions are neutralised by the sodium hydroxide and 40% in moles are neutralised by the calcium hydroxide.

### Test No. 17

This test illustrates the invention and uses 0.45% in dry weight, in relation to the dry weight of calcium carbonate, of a polymer:
consisting of acrylic acid, maleic anhydride (in a molar ratio r of 1.36:1) and 60% in weight (in relation to the total monomer weight) of acrylamido 2-methyl propane sulphonic acid;
with a molecular weight of 19,500 g/mole;
totally neutralised by the sodium hydroxide.

### Test No. 18

This test illustrates the invention and uses 0.45% in dry weight, in relation to the dry weight of calcium carbonate, of a polymer:
consisting of acrylic acid, maleic anhydride (in a molar ratio r of 1.36:1) and 10% in weight (in relation to the total monomer weight) of methoxy polyethylene glycol methacrylate with a molecular weight of 2000 g/mole;
with a molecular weight of 19,500 g/mole;
totally neutralised by the sodium hydroxide.

### Test No. 19

This test illustrates the prior art and uses 0.45% in dry weight, in relation to the dry weight of calcium carbonate, of a polymer:
consisting of acrylic acid and maleic anhydride in a molar ratio r of 3.17:1;
with a molecular weight of 15,700 g/mole;
totally neutralised by the sodium hydroxide.

### Test No. 20

This test illustrates the prior art and uses 0.5% in dry weight, in relation to the dry weight of calcium carbonate, of a polymer:
consisting of acrylic acid and maleic anhydride in a molar ratio r of 5.2:1;
with a molecular weight of 16,700 g/mole;
totally neutralised by the sodium hydroxide.

### Test No. 21

This test illustrates the prior art and uses 0.45% in dry weight, in relation to the dry weight of calcium carbonate, of a homopolymer of the acrylic acid with a molecular weight of 58,000 g/mole.

The Brookfield™ viscosity of the suspension is measured using an RVT type Brookfield™ viscometer at a temperature of 25° C. and at a rotation speed of 100 rpm with the appropriate mobile.

The viscosity reading is taken after one minute of rotation.

The initial viscosity of the suspension is thus obtained, measured at the instant t=0, and noted μₜ₌₀.

After a break of 8 days for said suspension, and after mechanical stirring of said suspension for 5 minutes using a laboratory stirrer, the Brookfield™ viscosity of said suspension is measured again using an RVT type Brookfield™ viscometer at a temperature of 25° C. and at a rotation speed of 100 rpm with the appropriate mobile, and noted μₜ₌₈.

These Brookfield™ viscosity values are given in table 2.

TABLE 2

| | μₜ₌₀ | μₜ₌₈ |
|---|---|---|
| | (mPa · s) | (mPa · s) |
| Test no. | 100 rpm | 100 rpm |
| 8 (invention) | 205 | 145 |
| 9 (invention) | 295 | 310 |
| 10 (invention) | 330 | 350 |
| 11 (invention) | 310 | 330 |
| 12 (invention) | 335 | 365 |
| 13 (invention) | 130 | 385 |
| 14 (invention) | 90 | 95 |
| 15 (invention) | 120 | 135 |
| 16 (invention) | 110 | 135 |
| 17 (invention) | 125 | 145 |
| 18 (invention) | 130 | 150 |
| 19 (prior art) | 400 | 620 |
| 20 (prior art) | 370 | 530 |
| 21 (prior art) | 950 | 1020 |

The reading of table 2 shows that the use of dispersants according to the invention, with the same quantity of dispersant as in the prior art, provides suspensions of calcium carbonate with the same solids content (65% of their weight), but lower initial Brookfield™ viscosities, providing good stability over time for said suspensions. The reading of this table thus clearly shows the technical advantage provided by the use of the polymers of the present invention, for the properties listed above.

Furthermore, the lowest Brookfield™ viscosity (at t=0) is obtained for tests no. 13 to 18, which correspond to a ratio r of 1.36, a value which falls within the very preferable range that the Applicant identified during its works.

### Example 3

This example illustrates the use according to the invention of the polymers described in the present Application and of polymers described in the prior art, as dispersing agents used in the method for grinding at low solids content without dispersing agent, then concentration to high solids content with dispersing agent present.

This example illustrates in particular the reduction of the requirement in dispersant in the case of the invention.

A filter cake identical to the one described in example 2 is dispersed with increasing doses of dispersant and the viscosities of the suspension are measured at the instant t=0 using an RVT type Brookfield™ viscometer at a temperature of 25° C. and at 100 rpm with the appropriate mobile, and noted μₜ₌₀. The viscosity reading is taken after one minute of rotation.

Test no. 22 is carried out with the polymer of the invention used for test no. 1. Test no. 23 is carried out with the polymer of the prior art used for test no. 19.

The results are given in table 3.

TABLE 3

| | test no. 22 | test no. 23 |
|---|---|---|
| | (invention) | (prior art) |
| | μₜ₌₀ | μₜ₌₀ |
| quantity of | (mPa · s) | (mPa · s) |
| dispersant* (%) | 100 rpm | 100 rpm |
| 0.2 | 900 | 1480 |
| 0.3 | 620 | 1050 |
| 0.4 | 350 | 800 |
| 0.5 | 260 | 640 |
| 1 | 150 | 200 |

*quantity given as a percentage in dry weight of dispersant in relation to the dry weight of calcium carbonate

The reading of table 3 shows that, for the same quantity of dispersing agent used, lower Brookfield™ viscosities are obtained in the case of the invention: this clearly illustrates the technical advantage provided by the use of polymers according to the present invention, compared to the polymers of the prior art.

1. A method for producing an aqueous dispersion and/or suspension of mineral materials including:
a) a grinding stage for mineral materials in an aqueous medium without the use of a dispersing agent and/or a grinding aid agent and with a percentage of mineral materials having a dry weight lower than 50% of its weight,
b) then a mechanical and/or thermal concentration stage, with a view to obtaining aqueous dispersions and/or suspensions of mineral materials with a percentage of mineral materials having a dry weight greater than 55% of its weight,
wherein at least one polymer containing at least one monomer chosen from acrylic acid, methacrylic acid and mixtures thereof and at least one monomer which is maleic anhydride, said polymer being characterised in that the molar ratio r (acrylic and/or methacrylic acid):(maleic anhydride) is strictly between 2:1 and 0.1:1, is used as a dispersing agent and is introduced between stage a) and stage b), and/or during stage b), and/or during and after stage b).

2. The method according to claim 1, characterised in that the molar ratio r (acrylic and/or methacrylic acid):(maleic anhydride) is between 1.9:1 and 1:1.

3. The method according to claim 1, characterised in that said polymer contains at least one other monomer, which is a non-acidic water soluble vinyl monomer, chosen from (meth)acrylamides which may be substituted, polyethylene glycol (meth)acrylates, polyalkylene glycol vinyl ethers, sulphonic vinyl, phosphate (meth)acrylates of polyalkylene glycol, vinyl pyrrolidone and mixtures thereof.

4. The method according to claim 3, characterised in that said polymer contains from 0 to 50% in moles, in relation to the total number of monomer moles it contains, of a non-acidic water soluble vinyl monomer, chosen from (meth)acrylamides which may be substituted, polyethylene glycol (meth)acrylates, polyalkylene glycol vinyl ethers, sulphonic vinyl, phosphate (meth)acrylates of polyalkylene glycol, vinyl pyrrolidone and mixtures thereof.

5. The method according to claim 1, characterised in that said polymer has a molecular weight of between 3000 g/mole and 150,000 g/mole.

6. The method according to claim 1, characterised in that said polymer is neutralised, totally or partially, by a neutralisation agent chosen from calcium or magnesium hydroxides and/or oxides, sodium, potassium, lithium hydroxides or ammonia, or mixtures thereof.

7. The method according to claim 1, characterised in that said polymer is used at 0.1% to 1.5% in dry weight of said polymer in relation to the dry weight of mineral materials.

8. The method according to claim 1, characterised in that said polymer is diluted in solution in the water, with this solution containing between 20% and 60% in dry weight of said polymer in relation to its total weight.

9. The method according to claim 1, characterised in that said mineral materials are chosen from natural or synthetic calcium carbonate, dolomites, kaolinite, talc, gypsum, lime, magnesia, titanium dioxide, satin white, aluminium trioxide or aluminium trihydroxide, silicas, mica and mixtures of talc-calcium carbonate, calcium carbonate-kaolinite, or mixtures of calcium carbonate with aluminium trihydroxide or aluminium trioxide, or mixtures with synthetic or natural fibres, or co-structures of minerals such as talc-calcium carbonate or talc-titanium dioxide co-structures, or mixtures thereof.

10. An aqueous dispersion or suspension of mineral materials, containing at least one polymer containing at least one monomer chosen from acrylic acid, methacrylic acid and mixtures thereof and at least one monomer which is maleic anhydride, characterised in that said polymer has a molar ratio r (acrylic and/or methacrylic acid):(maleic anhydride) strictly between 2:1 and 0.1:1, and in that it is obtained by a production process for the aqueous dispersion and/or suspension of mineral materials including:
a) a grinding stage for mineral materials in an aqueous medium without the use of a dispersing agent and/or a grinding aid agent and with a percentage of mineral materials having a dry weight lower than 50% of its weight,
b) then a mechanical and/or thermal concentration stage, with a view to obtaining aqueous dispersions and/or suspensions of mineral materials with a percentage of mineral materials having a dry weight greater than 55% of its weight,
wherein said polymer is used as a dispersing agent and is introduced between stage a) and stage b), and/or during stage b), and/or during and after stage b).

11. The dispersion or suspension according to claim 10, characterised in that the molar ratio r (acrylic and/or methacrylic acid):(maleic anhydride) is preferably between 1.9:1 and 1:1.

12. The dispersion or suspension according to claim 10, characterised in that said polymer contains at least one other monomer, which is a non-acidic water soluble vinyl monomer, chosen from (meth)acrylamides which may be substituted, polyethylene glycol (meth)acrylates, polyalkylene glycol vinyl ethers, sulphonic vinyl, phosphate (meth)acrylates of polyalkylene glycol, vinyl pyrrolidone and mixtures thereof.

13. The dispersion or suspension according to claim 12, characterised in that said polymer contains from 0 to 50% in moles, in relation to the total number of monomer moles it contains, of a non-acidic water soluble vinyl monomer, chosen from (meth)acrylamides which may be substituted, polyethylene glycol (meth)acrylates, polyalkylene glycol vinyl ethers, sulphonic vinyl, phosphate (meth)acrylates of polyalkylene glycol, vinyl pyrrolidone and mixtures thereof.

14. The dispersion or suspension according to claim 10, characterised in that said polymer has a molecular weight of between 3000 g/mole and 150,000 g/mole.

15. The dispersion or suspension according to claim 10, characterised in that said polymer is neutralised, totally or partially, by a neutralisation agent chosen from calcium or magnesium hydroxides and/or oxides, sodium, potassium, lithium hydroxides or ammonia, or mixtures thereof.

16. The dispersion or suspension according to claim 10, characterised in that said dispersion or suspension contains 0.1% to 1.5% in dry weight of said polymer in relation to the dry weight of mineral materials.

17. The dispersion or suspension according to claim 10, characterised in that said mineral materials are chosen from natural or synthetic calcium carbonate, dolomites, kaolinite, talc, gypsum, lime, magnesia, titanium dioxide, satin white, aluminium trioxide or aluminium trihydroxide, silicas, mica and mixtures of talc-calcium carbonate, calcium carbonate-kaolinite, or mixtures of calcium carbonate with aluminium trihydroxide or aluminium trioxide, or mixtures with synthetic or natural fibres, or co-structures of minerals such as talc-calcium carbonate or talc-titanium dioxide co-structures, or mixtures thereof.

18. A process for the production of plastics, rubbers and aqueous formulations containing mineral materials comprising the incorporation of the dispersion or suspension, according to claim 10.

19. A process for the production of a sheet of paper and of coating mixtures intended for the production of a coated sheet of paper comprising the incorporation of the dispersion or suspension, according to claim 10.

20. A process for the production of paintworks comprising the incorporation of the dispersion or suspension, according to claim 10.
